(19) United States
(12) Patent Application Publication
(10) Pub. No.: US 2022/0352601 A1
(43) Pub. Date: Nov. 3, 2022

(54) SECONDARY BATTERY

(71) Applicant: MURATA MANUFACTURING CO., LTD., Kyoto (JP)

(72) Inventor: Takaaki MATSUI, Kyoto (JP)

(21) Appl. No.: 17/859,403

(22) Filed: Jul. 7, 2022

Related U.S. Application Data
(63) Continuation of application No. PCT/JP2020/042438, filed on Nov. 13, 2020.

(30) Foreign Application Priority Data
Jan. 15, 2020 (JP) 2020-004502

(51) Int. Cl. H01M 50/46; H01M 10/0587; H01M 50/446; H01M 50/449; H01M 10/0525

(52) U.S. Cl. CPC H01M 50/46; H01M 10/0587; H01M 50/446; H01M 50/449; H01M 10/0525

(57) ABSTRACT

A secondary battery includes a battery device, a positive electrode terminal, a negative electrode terminal, and a porous member. The battery device includes a positive electrode and a negative electrode that are opposed to each other with a separator interposed therebetween. The positive electrode terminal is coupled to the positive electrode on a side of the positive electrode opposed to the negative electrode. The negative electrode terminal is coupled to the negative electrode on a side of the negative electrode opposed to the positive electrode. The negative electrode terminal is positioned not to be opposed to the positive electrode terminal. The porous member is disposed in a region sandwiched by the positive electrode terminal and the negative electrode terminal.

### CROSS REFERENCE TO RELATED APPLICATIONS

The present application is a continuation of PCT patent application no. PCT/JP2020/042438, filed Nov. 13, 2020, which claims priority to Japanese patent application no. JP 2020-004502, filed Jan. 15, 2020, the entire contents of which are being incorporated herein by reference.

### BACKGROUND

The present technology relates to a secondary battery.

Various kinds of electronic equipment, including mobile phones, have been widely used. Such widespread use has promoted development of a secondary battery as a power source that is smaller in size and lighter in weight and allows for a higher energy density. The secondary battery includes a positive electrode, a negative electrode, and an electrolytic solution which is a liquid electrolyte.

A configuration of the secondary battery influences a battery characteristic and has therefore been considered in various ways. For example, in a secondary battery including a wound electrode body having an elongated sectional shape, a step-reducing member is provided in the vicinity of each of a positive electrode terminal and a negative electrode terminal in order to achieve a superior cyclability characteristic.

### SUMMARY

The present application relates to a secondary battery.

Although consideration has been given in various ways to improve a battery characteristic of a secondary battery, a cyclability characteristic of the secondary battery is not sufficient yet. Accordingly, there is still room for improvement in terms thereof.

The present technology has been made in view of such an issue and relates to providing a secondary battery that makes it possible to achieve a superior cyclability characteristic according to an embodiment.

A secondary battery according to an embodiment includes a battery device, a positive electrode terminal, a negative electrode terminal, and a porous member. The battery device includes a positive electrode and a negative electrode that are opposed to each other with a separator interposed therebetween. The positive electrode terminal is coupled to the positive electrode on a side of the positive electrode opposed to the negative electrode. The negative electrode terminal is coupled to the negative electrode on a side of the negative electrode opposed to the positive electrode. The negative electrode terminal is positioned not to be opposed to the positive electrode terminal. The porous member is disposed in a region sandwiched by the positive electrode terminal and the negative electrode terminal.

According to an embodiment, the positive electrode and the negative electrode are opposed to each other with the separator interposed therebetween. The positive electrode terminal is coupled to the positive electrode on the side of the positive electrode opposed to the negative electrode. The negative electrode terminal is coupled to the negative electrode on the side of the negative electrode opposed to the positive electrode, at a position not opposed to the positive electrode terminal. The porous member is disposed in the region sandwiched by the positive electrode terminal and the negative electrode terminal. Accordingly, it is possible to achieve a superior cyclability characteristic.

Note that effects of the present technology are not necessarily limited to those described herein and may include any of a suitable series of effects in relation to the present technology.

### BRIEF DESCRIPTION OF THE FIGURES

FIG. 1 is a perspective diagram illustrating a configuration of a secondary battery according to an embodiment of the present technology.

FIG. 2 is a sectional diagram illustrating a configuration of a battery device illustrated in FIG. 1.

FIG. 3 is another sectional diagram schematically illustrating the configuration of the battery device illustrated in FIG. 1.

FIG. 4 is an enlarged sectional diagram illustrating the configuration of the battery device illustrated in FIG. 2.

FIG. 5 is an enlarged sectional diagram illustrating a configuration of a separator illustrated in FIG. 4.

FIG. 6 is an enlarged sectional diagram illustrating a configuration of a main part of the battery device illustrated in FIG. 2.

FIG. 7 is a sectional diagram illustrating a configuration of a secondary battery of a comparative example.

FIG. 8 is a sectional diagram illustrating a configuration of a secondary battery of an embodiment.

FIG. 9 is a sectional diagram illustrating a configuration of a secondary battery of an embodiment.

FIG. 10 is a sectional diagram illustrating a configuration of a secondary battery of an embodiment.

FIG. 11 is a block diagram illustrating a configuration of an application example of the secondary battery, which is a battery pack.

### DETAILED DESCRIPTION

The present application will be described in further detail below with reference to the drawings according to an embodiment.

A description is given first of a secondary battery according to an embodiment of the present technology.

The secondary battery to be described here is a secondary battery that obtains a battery capacity using insertion and extraction of an electrode reactant, and includes a positive electrode, a negative electrode, and an electrolytic solution. In the secondary battery, to prevent unintentional precipitation of the electrode reactant on a surface of the negative electrode during charging, a charge capacity of the negative electrode is greater than a discharge capacity of the positive electrode. In other words, an electrochemical capacity per unit area of the negative electrode is greater than an electrochemical capacity per unit area of the positive electrode.

Although not particularly limited in kind, the electrode reactant is specifically a light metal such as an alkali metal or an alkaline earth metal. Examples of the alkali metal include lithium, sodium, and potassium. Examples of the alkaline earth metal include beryllium, magnesium, and calcium.

Examples are given below of a case where the electrode reactant is lithium. A secondary battery that obtains a battery capacity using insertion and extraction of lithium is a so-called lithium-ion secondary battery. In the lithium-ion secondary battery, lithium is inserted and extracted in an ionic state.

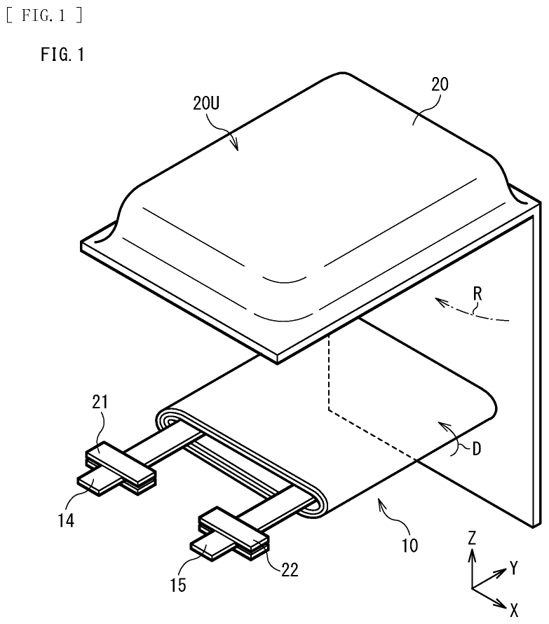

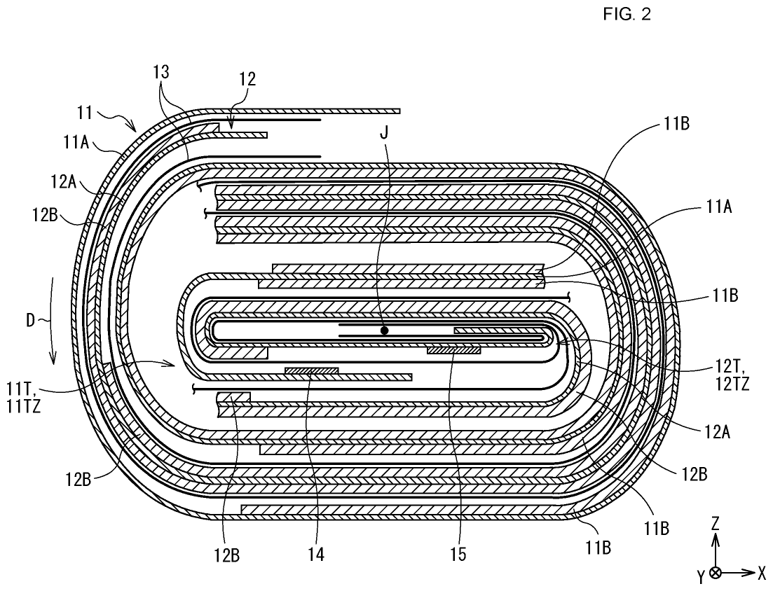

FIG. 1 illustrates a perspective configuration of the secondary battery. FIG. 2 illustrates a sectional configuration of a battery device 10 illustrated in FIG. 1. FIG. 3 schematically illustrates the sectional configuration of the battery device 10 illustrated in FIG. 1. Note that FIG. 1 illustrates a state in which the battery device 10 and an outer package film 20 are separated away from each other, and FIG. 3 illustrates a section of the battery device 10 intersecting a winding axis J extending in a Y-axis direction.

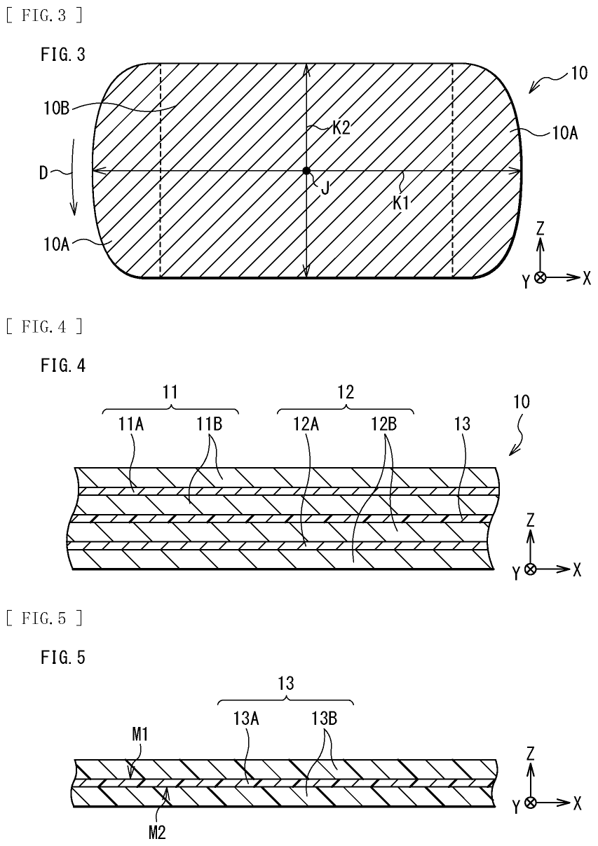

FIG. 4 illustrates an enlarged sectional configuration of the battery device 10 illustrated in FIG. 2. FIG. 5 illustrates an enlarged sectional configuration of a separator 13 illustrated in FIG. 4. Note that FIG. 4 illustrates only respective portions of a positive electrode 11, a negative electrode 12, and the separator 13, and FIG. 5 illustrates only a portion of the separator 13.

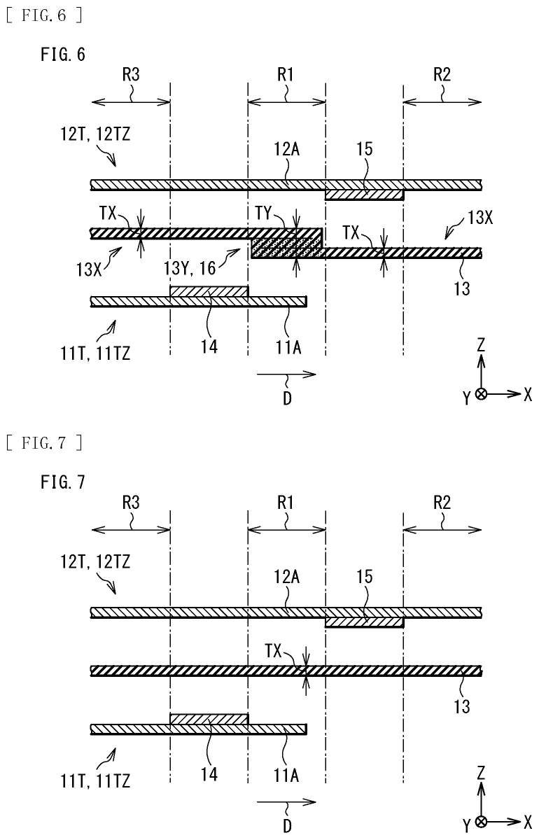

FIG. 6 illustrates an enlarged sectional configuration of a main part (i.e., a portion near a location where a porous film 16 is provided) of the battery device 10 illustrated in FIG. 2. For ease of viewing of the configuration of the separator 13, FIG. 6 illustrates a state in which a positive electrode end part 11T (a positive electrode extending part 11TZ) and the separator 13 are separated away from each other and in which a negative electrode end part 12T (a negative electrode extending part 12TZ) and the separator 13 are separated away from each other.

As illustrated in FIGS. 1 to 6, the secondary battery includes the battery device 10, the outer package film 20, a positive electrode lead 14, a negative electrode lead 15, and the porous film 16. The battery device 10 is contained inside the outer package film 20. The positive electrode lead 14 and the negative electrode lead 15 are led out in a common direction from inside to outside the outer package film 20.

The secondary battery described here is a secondary battery of a laminated-film type. The secondary battery of the laminated-film type includes an outer package member having flexibility or softness, that is, the outer package film 20, as an outer package member to contain the battery device 10.

The outer package film 20 is a single film-shaped member and is foldable in a direction of an arrow R (a dash-dotted line), as illustrated in FIG. 1. The outer package film 20 contains the battery device 10 as described above, and thus contains the positive electrode 11, the negative electrode 12, and an electrolytic solution. The outer package film 20 has a depression part 20U to place the battery device 10 therein. The depression part 20U is a so-called deep drawn part.

Specifically, the outer package film 20 is a three-layered laminated film including a fusion-bonding layer, a metal layer, and a surface protective layer that are stacked in this order from an inner side. In a state in which the outer package film 20 is folded, outer edges of the fusion-bonding layer opposed to each other are fusion-bonded to each other. The fusion-bonding layer includes a polymer compound such as polypropylene. The metal layer includes a metal material such as aluminum. The surface protective layer includes a polymer compound such as nylon.

Note that the outer package film 20 is not particularly limited in configuration or the number of layers, and may be single-layered or two-layered, or may include four or more layers.

A sealing film 21 is interposed between the outer package film 20 and the positive electrode lead 14. A sealing film 22 is interposed between the outer package film 20 and the negative electrode lead 15. The sealing films 21 and 22 are members that each prevent unintentional entry of outside air into the outer package film 20, and each include one or more of polymer compounds, including polyolefin, that have adherence to both the positive electrode lead 14 and the negative electrode lead 15. Examples of the polyolefin include polyethylene, polypropylene, modified polyethylene, and modified polypropylene. Note that the sealing film 21, the sealing film 22, or both may be omitted.

As illustrated in FIGS. 1 to 5, the battery device 10 includes the positive electrode 11, the negative electrode 12, the separator 13, and the electrolytic solution (not illustrated) which is a liquid electrolyte. The positive electrode 11, the negative electrode 12, and the separator 13 are each impregnated with the electrolytic solution.

As illustrated in FIGS. 1 to 3, the battery device 10 is a structure in which the positive electrode 11 and the negative electrode 12 are wound in a winding direction D with the separator 13 interposed therebetween, and is a so-called wound electrode body. More specifically, in the battery device 10 which is the wound electrode body, the positive electrode 11 and the negative electrode 12 are stacked on each other with the separator 13 interposed therebetween, and the stack of the positive electrode 11, the negative electrode 12, and the separator 13 is wound about the winding axis J in the winding direction D. In other words, the positive electrode 11 and the negative electrode 12 are wound together with the separator 13 in the winding direction D while being opposed to each other with the separator 13 interposed therebetween.

As illustrated in FIG. 3, a section of the battery device 10 intersecting the winding axis J, that is, a section of the battery device 10 along an XZ plane, has an elongated shape defined by a major axis K1 and a minor axis K2, and more specifically, has an elongated, generally elliptical shape. The major axis K1 is an axis (a horizontal axis) that extends in an X-axis direction and has a relatively large length. The minor axis K2 is an axis (a vertical axis) that extends in the Y-axis direction intersecting the X-axis direction and has a relatively small length.

Thus, the battery device 10 which is the wound electrode body has an elongated three-dimensional shape as a whole. Accordingly, as illustrated in FIG. 3, the battery device 10 includes paired curved parts 10A, and a flat part 10B lying between the curved parts 10A. The curved part 10A is a part in which the positive electrode 11, the negative electrode 12, and the separator 13 are so curved as to trace a curved line. In contrast, the flat part 10B is a substantially flat part in which the positive electrode 11, the negative electrode 12, and the separator 13 are non-curved. In FIG. 3, a boundary between the curved part 10A and the flat part 10B is indicated by a broken line.

As illustrated in FIGS. 2 and 4, the positive electrode 11 includes a positive electrode current collector 11A, and two positive electrode active material layers 11B provided on respective opposite sides of the positive electrode current collector 11A. Note that the positive electrode active material layer 11B may be provided only on one of the opposite sides of the positive electrode current collector 11A.

The positive electrode current collector 11A includes one or more of electrically conductive materials including, without limitation, a metal material. Examples of the metal material include aluminum, nickel, and stainless steel. The positive electrode active material layer 11B includes one or more of positive electrode active materials into which lithium is insertable and from which lithium is extractable. Note that the positive electrode active material layer 11B may further include, for example, a positive electrode binder and a positive electrode conductor.

Although not particularly limited in kind, the positive electrode active material is specifically a lithium-containing compound such as a lithium-containing transition metal compound. The lithium-containing transition metal compound includes lithium and one or more transition metal elements, and may further include one or more other elements. The other elements may be any elements other than transition metal elements, and are not particularly limited in kind. Specifically, however, the other elements are elements belonging to groups 2 to 15 in the long period periodic table of elements. The lithium-containing transition metal compound is not particularly limited in kind, and specific examples thereof include an oxide, a phosphoric acid compound, a silicic acid compound, and a boric acid compound.

Specific examples of the oxide include LiNiO₂, LiCoO₂, LiCo_{0.98}Al_{0.01}Mg_{0.01}O₂, LiNi_{0.5}Co_{0.2}Mn_{0.3}O₂, LiNi_{0.8}Co_{0.15}Al_{0.05}O₂, LiNi_{0.33}Co_{0.33}Mn_{0.33}O₂, Li_{1.2}Mn_{0.52}Co_{0.175}Ni_{0.1}O₂, Li_{1.15}(Mn_{0.65}Ni_{0.22}Co_{0.13})O₂, and LiMn₂O₄. Specific examples of the phosphoric acid compound include LiFePO₄, LiMnPO₄, LiFe_{0.5}Mn_{0.5}PO₄, and LiFe_{0.3}Mn_{0.7}PO₄.

Here, as illustrated in FIG. 2, the positive electrode active material layer 11B is provided only partially on the positive electrode current collector 11A in the winding direction D. Accordingly, at an end part of the positive electrode 11 on an inner side of winding, that is, at the positive electrode end part 11T, the positive electrode current collector 11A is not covered with the positive electrode active material layer 11B and is thus exposed; and at an end part of the positive electrode 11 on an outer side of the winding, the positive electrode current collector 11A is not covered with the positive electrode active material layer 11B and is thus exposed.

The positive electrode end part 11T includes the positive electrode extending part 11TZ extending in the direction of the foregoing major axis K1, that is, in the X-axis direction. As illustrated in FIG. 6, the positive electrode extending part 11TZ is a substantially linear portion of the positive electrode end part 11T, extending in the X-axis direction without being curved.

The positive electrode binder includes one or more of materials including, without limitation, a synthetic rubber and a polymer compound. Examples of the synthetic rubber include a styrene-butadiene-based rubber, a fluorine-based rubber, and ethylene propylene diene. Examples of the polymer compound include polyvinylidene difluoride, polyimide, and carboxymethyl cellulose.

The positive electrode conductor includes one or more of electrically conductive materials including, without limitation, a carbon material. Examples of the carbon material include graphite, carbon black, acetylene black, and Ketjen black. The electrically conductive material may be a metal material or a polymer compound, for example.

As illustrated in FIGS. 2 and 4, the negative electrode 12 includes a negative electrode current collector 12A, and two negative electrode active material layers 12B provided on respective opposite sides of the negative electrode current collector 12A. Note that the negative electrode active material layer 12B may be provided only on one of the opposite sides of the negative electrode current collector 12A.

The negative electrode current collector 12A includes one or more of electrically conductive materials including, without limitation, a metal material. Examples of the metal material include copper, aluminum, nickel, and stainless steel. The negative electrode active material layer 12B includes one or more of negative electrode active materials into which lithium is insertable and from which lithium is extractable. Note that the negative electrode active material layer 12B may further include, for example, a negative electrode binder and a negative electrode conductor. Details of the negative electrode binder are similar to those of the positive electrode binder described above. Details of the negative electrode conductor are similar to those of the positive electrode conductor described above.

The negative electrode active material is not particularly limited in kind, and specific examples thereof include a carbon material and a metal-based material. Examples of the carbon material include graphitizable carbon, non-graphitizable carbon, and graphite. Examples of the graphite include natural graphite and artificial graphite. The metal-based material is a material that includes one or more elements among metal elements and metalloid elements that are each able to form an alloy with lithium. Examples of such metal elements and metalloid elements include silicon and tin. The metal-based material may be a simple substance, an alloy, a compound, a mixture of two or more thereof, or a material including two or more phases thereof.

Specific examples of the metal-based material include SiB₄, SiB₆, Mg₂Si, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, SiC, Si₃N₄, Si₂N₂O, SiOᵥ (0<v≤2), LiSiO, SnO_{w} (0<w≤2), SnSiO₃, LiSnO, and Mg₂Sn. Note that “v” of SiOᵥ may satisfy 0.2<v<1.4.

A method of forming the negative electrode active material layer 12B is not particularly limited, and specifically, one or more methods are selected from among a coating method, a vapor-phase method, a liquid-phase method, a thermal spraying method, a firing (sintering) method, and other methods.

Here, as illustrated in FIG. 2, the negative electrode active material layer 12B is provided only partially on the negative electrode current collector 12A in the winding direction D. Accordingly, at an end part of the negative electrode 12 on the inner side of the winding, that is, at the negative electrode end part 12T, the negative electrode current collector 12A is not covered with the negative electrode active material layer 12B and is thus exposed; and at an end part of the negative electrode 12 on the outer side of the winding, the negative electrode current collector 12A is not covered with the negative electrode active material layer 12B and is thus exposed.

The negative electrode end part 12T includes the negative electrode extending part 12TZ extending in the direction of the foregoing major axis K1, that is, in the X-axis direction. As illustrated in FIG. 6, the negative electrode extending part 12TZ is a substantially linear portion of the negative electrode end part 12T, extending in the X-axis direction without being curved. As a result, the positive electrode extending part 11TZ and the negative electrode extending part 12TZ extend while being opposed to each other with the separator 13 interposed therebetween.

The separator 13 is an insulating porous film interposed between the positive electrode 11 and the negative electrode 12 as illustrated in FIGS. 2 and 4, and allows lithium ions to pass therethrough while preventing a contact between the positive electrode 11 and the negative electrode 12. For simplifying the illustration, the separator 13 is illustrated in a linear shape in FIG. 2.

Here, the separator 13 has a multilayer structure including polymer compound layers 13B described below. Specifically, as illustrated in FIG. 5, the separator 13 includes a porous layer 13A and two polymer compound layers 13B provided on respective opposite sides of the porous layer 13A. A reason for this is that adherence of the separator 13 to each of the positive electrode 11 and the negative electrode 12 improves to suppress the occurrence of positional displacement of the battery device 10. This helps to prevent the secondary battery from easily swelling even if, for example, a decomposition reaction of the electrolytic solution occurs.

The porous layer 13A includes one or more of polymer compounds including, without limitation, polytetrafluoroethylene, polypropylene, and polyethylene. The porous layer 13A has paired surfaces, that is, opposed surfaces M1 and M2. The opposed surface M1 is a surface of the porous layer 13A on a side opposed to the positive electrode 11. The opposed surface M2 is a surface of the porous layer 13A on a side opposed to the negative electrode 12. Note that the porous layer 13A may be single-layered or multilayered.

The polymer compound layer 13B is provided on each of opposite sides of the porous layer 13A, and is thus provided on each of the surfaces M1 and M2.

The polymer compound layer 13B includes a polymer compound and inorganic particles. A reason for this is that the inorganic particles dissipate heat upon heat generation by the secondary battery, and this improves heat resistance and safety of the secondary battery. Note that the polymer compound layer 13B may be single-layered or multilayered.

The polymer compound includes one or more of polymer compounds including, without limitation, polyvinylidene difluoride. A reason for this is that superior physical strength and electrochemical stability are achievable. The inorganic particles include one or more of inorganic materials including, without limitation, aluminum oxide (alumina), aluminum nitride, boehmite, silicon oxide (silica), titanium oxide (titania), magnesium oxide (magnesia), and zirconium oxide (zirconia).

Note that the separator 13 may have a single-layer structure. A configuration of the separator 13 having the single-layer structure is similar to the configuration of the porous layer 13A described above.

The electrolytic solution includes a solvent and an electrolyte salt.

The solvent includes one or more of non-aqueous solvents (organic solvents). The electrolytic solution including a non-aqueous solvent is a so-called non-aqueous electrolytic solution. Examples of the non-aqueous solvent include esters and ethers. More specific examples of the non-aqueous solvent include a carbonic-acid-ester-based compound, a carboxylic-acid-ester-based compound, and a lactone-based compound.

Examples of the carbonic-acid-ester-based compound include a cyclic carbonic acid ester and a chain carbonic acid ester. Examples of the cyclic carbonic acid ester include ethylene carbonate and propylene carbonate. Examples of the chain carbonic acid ester include dimethyl carbonate, diethyl carbonate, and methyl ethyl carbonate. Examples of the carboxylic-acid-ester-based compound include ethyl acetate, ethyl propionate, and ethyl trimethyl acetate. Examples of the lactone-based compound include γ-butyrolactone and γ-valerolactone. Examples of the ethers other than the lactone-based compounds described above include 1,2-dimethoxy ethane, tetrahydrofuran, 1,3-dioxolane, and 1,4-dioxane.

Further, examples of the non-aqueous solvent include an unsaturated cyclic carbonic acid ester, a halogenated carbonic acid ester, a sulfonic acid ester, a phosphoric acid ester, an acid anhydride, a nitrile compound, and an isocyanate compound. A reason for this is that chemical stability of the electrolytic solution improves.

Specific examples of the unsaturated cyclic carbonic acid ester include vinylene carbonate, vinylethylene carbonate, and methylene ethylene carbonate. Examples of the halogenated carbonic acid ester include monofluoroethylene carbonate and difluoroethylene carbonate. Examples of the sulfonic acid ester include 1,3-propane sultone and 1,3-propene sultone. Examples of the phosphoric acid ester include trimethyl phosphate. Examples of the acid anhydride include a cyclic carboxylic acid anhydride, a cyclic disulfonic acid anhydride, and a cyclic carboxylic acid sulfonic acid anhydride. Examples of the cyclic carboxylic acid anhydride include a succinic acid anhydride, a glutaric acid anhydride, and a maleic acid anhydride. Examples of the cyclic disulfonic acid anhydride include an ethane disulfonic acid anhydride and a propane disulfonic acid anhydride. Examples of the cyclic carboxylic acid sulfonic acid anhydride include a sulfobenzoic acid anhydride, a sulfopropionic acid anhydride, and a sulfobutyric acid anhydride. Examples of the nitrile compound include acetonitrile, acrylonitrile, malononitrile, succinonitrile, glutaronitrile, adiponitrile, sebaconitrile, and phthalonitrile. Examples of the isocyanate compound include hexamethylene diisocyanate.

The electrolyte salt includes one or more of light metal salts including, without limitation, a lithium salt. Examples of the lithium salt include lithium hexafluorophosphate (LiPF₆), lithium tetrafluoroborate (LiBF₄), lithium trifluoromethanesulfonate (LiCF₃SO₃), lithium bis(fluorosulfonyl)imide (LiN(FSO₂)₂), lithium bis(trifluoromethanesulfonyl)imide (LiN(CF₃SO₂)₂), lithium tris(trifluoromethanesulfonyl)methide (LiC(CF₃SO₂)₃), and lithium bis(oxalato)borate (LiB(C₂O₄)₂). Although not particularly limited, a content of the electrolyte salt is specifically within a range from 0.3 mol/kg to 3.0 mol/kg both inclusive with respect to the solvent. A reason for this is that a high ionic conductivity is obtainable.

The positive electrode lead 14 is a positive electrode terminal coupled to the positive electrode 11, and is coupled to the positive electrode 11 on a side of the positive electrode 11 opposed to the negative electrode 12. The positive electrode lead 14 includes one or more of electrically conductive materials including, without limitation, aluminum. The negative electrode lead 15 is a negative electrode terminal coupled to the negative electrode 12, and is coupled to the negative electrode 12 on a side of the negative electrode 12 opposed to the positive electrode 11. The negative electrode lead 15 includes one or more of electrically conductive materials including, without limitation, copper, nickel, and stainless steel. The positive electrode lead 14 and the negative electrode lead 15 each have a shape such as a thin plate shape or a meshed shape.

Here, as described above, the battery device 10 includes the paired curved parts 10A and the flat part 10B. In this case, the positive electrode lead 14 is coupled to the positive electrode 11 at the flat part 10B, and the negative electrode lead 15 is coupled to the negative electrode 12 at the flat part 10B.

More specifically, as described above, the positive electrode 11 includes the positive electrode end part 11T at an end on the inner side of the winding in the winding direction D. The positive electrode current collector 11A is exposed at the positive electrode end part 11T. Accordingly, the positive electrode lead 14 is coupled to the positive electrode end part 11T, more specifically, to the positive electrode extending part 11TZ. A reason for this is that an electrical conductivity between the positive electrode lead 14 and the positive electrode 11 improves.

Further, as described above, the negative electrode 12 includes the negative electrode end part 12T at an end on the inner side of the winding in the winding direction D. The negative electrode current collector 12A is exposed at the negative electrode end part 12T. Accordingly, the negative electrode lead 15 is coupled to the negative electrode end part 12T, more specifically, to the negative electrode extending part 12TZ. A reason for this is that an electrical conductivity between the negative electrode lead 15 and the negative electrode 12 improves.

Note that the negative electrode lead 15 is positioned not to be opposed to the positive electrode lead 14. In other words, the negative electrode lead 15 is positioned not to overlap the positive electrode lead 14 with the separator 13 interposed therebetween. Accordingly, as illustrated in FIG. 2, the position of the positive electrode lead 14 and the position of the negative electrode lead 15 are displaced from each other in the winding direction D. Here, the negative electrode lead 15 lies on the inner side of the winding relative to the positive electrode lead 14 in the winding direction D.

The number of the positive electrode leads 14 is not particularly limited, and may thus be one, or two or more. The number of the negative electrode leads 15 is not particularly limited, and may thus be one, or two or more. If the number of the positive electrode leads 14 and the number of the negative electrodes lead 15 are each two or more, in particular, the secondary battery decreases in electrical resistance. Note that in the case where the number of the positive electrode leads 14 and the number of the negative electrode leads 15 are each two or more, there are two or more inter-lead regions R1 to be described later.

The porous film 16 is a porous member that helps to prevent a winding state of the battery device 10 (the positive electrode 11 and the negative electrode 12) from being affected by a level difference that results from the presence of each of the positive electrode lead 14 and the negative electrode lead 15.

The porousness of the porous film 16 mainly serves to secure movement of the lithium ions and to hold the electrolytic solution. As a result, the presence of the porous film 16 does not hinder movement of the lithium ions, and the positive electrode 11 and the negative electrode 12 are each impregnated with the electrolytic solution in a sufficient amount through the porous film 16. In this case, in particular, a surplus electrolytic solution to be described later is secured by the porous film 16.

As described above, the position of the positive electrode lead 14 and the position of the negative electrode lead 15 are displaced from each other in the winding direction D. In this case, the porous film 16 is disposed in a region sandwiched by the positive electrode lead 14 and the negative electrode lead 15.

Here, the positive electrode 11 and the negative electrode 12 are wound with the separator 13 interposed therebetween. Accordingly, as illustrated in FIG. 6, the porous film 16 is disposed in the inter-lead region R1 (a first region). The inter-lead region R1 is a region sandwiched by the positive electrode lead 14 and the negative electrode lead 15 in the winding direction D, that is, a region lying between the positive electrode lead 14 and the negative electrode lead 15 in the winding direction D.

The porous film 16 serves to locally increase a thickness of the separator 13 in the inter-lead region R1. This reduces a level difference (a difference in height) that results from the presence of each of the positive electrode lead 14 and the negative electrode lead 15, and thus helps to prevent each of the positive electrode 11 and the negative electrode 12 from being excessively curved to conform to the level difference. Accordingly, flatness of each of the positive electrode 11 and the negative electrode 12 is secured by the porous film 16 even in the presence of each of the positive electrode lead 14 and the negative electrode lead 15. This helps to prevent the winding state of the battery device 10 from being affected by the level difference resulting from the presence of each of the positive electrode lead 14 and the negative electrode lead 15, as described above.

Further, the porous film 16 includes a material similar to a material included in the separator 13 (the porous layer 13A). Note that the material included in the porous film 16 may be the same as or different from the material included in the porous layer 13A.

Here, as illustrated in FIG. 6, the separator 13 is folded in part in the inter-lead region R1, and therefore the porous film 16 is a portion of the separator 13. In other words, the porous film 16 is integral with the separator 13. In this case, because the separator 13 is folded in part in the inter-lead region R1, the thickness of the separator 13 is locally increased in the inter-lead region R1. Further, the material included in the porous film 16 is the same as the material included in the porous layer 13A.

In the case where the separator 13 is folded in part, the portion, of the separator 13 folded in part, that locally increases the thickness is the porous film 16. The porous film 16, in other words, the portion of the separator 13 corresponding to the porous film 16, is shaded in FIG. 6.

In this case, the separator 13 includes paired constant-thickness parts 13X and an increased-thickness part 13Y. The paired constant-thickness parts 13X are disposed in respective regions other than the lead region R1, and the increased-thickness part 13Y is disposed in the inter-lead region R1. Thus, the increased-thickness part 13Y is disposed between the paired constant-thickness parts 13X, and is coupled to each of the paired constant-thickness parts 13X.

The constant-thickness part 13X is a part where the separator 13 is not folded in part, and thus has a thickness TX equal to the thickness of the separator 13 itself (i.e., the thickness in a state of not being folded in part). The increased-thickness part 13Y is a part where the separator 13 is folded in part, and thus has a thickness TY larger than the foregoing thickness TX.

Here, the separator 13 is folded in a direction opposite to the winding direction D, and then further folded in the opposite direction thereto, thus being folded twice. As a result, the separator 13 is folded locally in three thicknesses, and therefore the thickness of the separator 13 is increased threefold in the inter-lead region R1. That is, the thickness TY of the increased-thickness part 13Y is three times the thickness TX of the constant-thickness part 13X. In this case, of the increased-thickness part 13Y having the thickness TY three times the thickness TX, a portion (the shaded portion) having a thickness twice the thickness TX is the porous film 16.

Note that the configuration of the separator 13 is not particularly limited as long as it is possible to provide the porous film 16 in the inter-lead region R1 through the use of a portion of the separator 13 by locally increasing the thickness of the separator 13. That is, for example, the direction of folding, the manner of folding, and the number of folds are not particularly limited, and may be freely chosen.

In particular, the increased-thickness part 13Y is preferably in contact with the positive electrode 11 (the positive electrode end part 11T), the negative electrode 12 (the negative electrode end part 12T), or both. A reason for this is that this allows the positive electrode 11, the negative electrode 12, or both to be supported by the increased-thickness part 13Y. Accordingly, the three-dimensional shape (an elongated shape) of the battery device 10 is prevented from being distorted easily, and it is thus easier to maintain the three-dimensional shape, or the shaped state, of the battery device 10.

Note that because the battery device 10 has an elongated shape in a section intersecting the winding axis J as described above, the positive electrode end part 11T includes the positive electrode extending part 11TZ extending in the direction of the major axis K1, and the negative electrode end part 12T includes the negative electrode extending part 12TZ extending in the same direction. In this case, as illustrated in FIG. 6, three regions including the inter-lead region R1, that is, the inter-lead region R1, an inner winding region R2 (a second region), and an outer winding region R3 (a third region), are present within a range over which the positive electrode extending part 11TZ and the negative electrode extending part 12TZ each extend.

As described above, the inter-lead region R1 is a region sandwiched by the positive electrode lead 14 and the negative electrode lead 15 in the winding direction D. The inner winding region R2 is a region lying on the inner side of the winding (the right side in FIG. 5) relative to the negative electrode lead 15 in a case where the negative electrode lead 15 lies on the inner side of the winding relative to the positive electrode lead 14. The outer winding region R3 is a region lying on the outer side of the winding (the left side in FIG. 5) relative to the positive electrode lead 14 in the case where the negative electrode lead 15 lies on the inner side of the winding relative to the positive electrode lead 14.

Note that the positive electrode lead 14 may be disposed on the inner side of the winding relative to the negative electrode lead 15 in the winding direction D. In this case, although not specifically illustrated here, a region lying on the inner side of the winding relative to the positive electrode lead 14 is the inner winding region R2, and a region lying on the outer side of the winding relative to the negative electrode lead 15 is the outer winding region R3.

Here, as described above, because the separator 13 is folded in part in the inter-lead region R1, the porous film 16 is disposed in the inter-lead region R1. In contrast, the separator 13 is folded in part neither in the inner winding region R2 nor in the outer winding region R3, and therefore the porous film 16 is disposed neither in the inner winding region R2 nor in the outer winding region R3.

Note that in the inter-lead region R1, there is no particular limitation to a range over which the porous film 16 is to be provided. However, the porous film 16 preferably has an area that is small to some extent relative to the area of the inter-lead region R1. A reason for this is that this makes it easier to place the porous film 16 in the space sandwiched by the positive electrode lead 14 and the negative electrode lead 15, and thus makes it easier to reduce the level difference through the use of the porous film 16. Note that the area described here refers to an area of a surface along an XY plane.

In particular, a ratio of the area S2 of the porous film 16 to the area S1 of the inter-lead region R1, i.e., an area ratio S(=S2/S1), is preferably within a range from 20% to 80% both inclusive. A reason for this is that this sufficiently facilitates placement of the porous film 16 in the space sandwiched by the positive electrode lead 14 and the negative electrode lead 15, thus making it easier to sufficiently reduce the level difference through the use of the porous film 16.

Upon charging the secondary battery, lithium is extracted from the positive electrode 11, and the extracted lithium is inserted into the negative electrode 12 via the electrolytic solution. Upon discharging the secondary battery, lithium is extracted from the negative electrode 12, and the extracted lithium is inserted into the positive electrode 11 via the electrolytic solution. Upon charging and discharging the secondary battery, lithium is inserted and extracted in an ionic state.

In a case of manufacturing the secondary battery, the positive electrode 11 and the negative electrode 12 are fabricated and the electrolytic solution is prepared, following which the secondary battery is fabricated using the positive electrode 11, the negative electrode 12, and the electrolytic solution, according to a procedure to be described below. In the following description, the respective illustrations of FIGS. 1 to 6 described already will be referenced where appropriate.

First, the positive electrode active material is mixed with, for example, the positive electrode binder and the positive electrode conductor on an as-needed basis to thereby obtain a positive electrode mixture. Thereafter, the positive electrode mixture is put into a solvent such as an organic solvent to thereby prepare a paste positive electrode mixture slurry. Lastly, the positive electrode mixture slurry is applied on opposite sides of the positive electrode current collector 11A to thereby form the positive electrode active material layers 11B. In this case, an application range of the positive electrode mixture slurry is adjusted to allow the positive electrode active material layers 11B to be formed on respective portions of the opposite sides of the positive electrode current collector 11A, as described above. Thereafter, the positive electrode active material layers 11B may be compression-molded by means of a machine such as a roll pressing machine. In this case, the positive electrode active material layers 11B may be heated. The positive electrode active material layers 11B may be compression-molded multiple times. The positive electrode active material layers 11B are thus formed on the respective opposite sides of the positive electrode current collector 11A. In this manner, the positive electrode 11 is fabricated.

The negative electrode active material layers 12B are formed on respective opposite sides of the negative electrode current collector 12A by a procedure similar to the fabrication procedure of the positive electrode 11 described above. Specifically, the negative electrode active material is mixed with, for example, the negative electrode binder and the negative electrode conductor on an as-needed basis to thereby obtain a negative electrode mixture. Thereafter, the negative electrode mixture is put into a solvent such as an organic solvent to thereby prepare a paste negative electrode mixture slurry. Thereafter, the negative electrode mixture slurry is applied on the opposite sides of the negative electrode current collector 12A to thereby form the negative electrode active material layers 12B. In this case, an application range of the negative electrode mixture slurry is adjusted to allow the negative electrode active material layers 12B to be formed on respective portions of the opposite sides of the negative electrode current collector 12A, as described above. Thereafter, the negative electrode active material layers 12B may be compression-molded. The negative electrode active material layers 12B are thus formed on the respective opposite sides of the negative electrode current collector 12A. In this manner, the negative electrode 12 is fabricated.

The electrolyte salt is put into a solvent. The electrolyte salt is thereby dispersed or dissolved in the solvent. As a result, the electrolytic solution is prepared.

First, the porous layer 13A having the opposed surfaces M1 and M2 is prepared. Thereafter, the polymer compound and the inorganic particles are put into a solvent such as an organic solvent to thereby prepare a paste slurry. Thereafter, the slurry is applied on opposite sides (the opposed surfaces M1 and M2) of the porous layer 13A to thereby form the polymer compound layers 13B. Lastly, the porous layer 13A with the polymer compound layers 13B formed thereon is folded in part to thereby form the constant-thickness parts 13X and the increased-thickness part 13Y. In this case, the formation position of the increased-thickness part 13Y is adjusted to allow the increased-thickness part 13Y to be disposed in the inter-lead region R1 upon fabrication of the battery device 10 to be described later, that is, upon winding of the positive electrode 11, the negative electrode 12, and the separator 13. Thus, the polymer compound layers 13B are formed on the respective opposite sides of the porous layer 13A, and the constant-thickness parts 13X and the increased-thickness part 13Y are also formed. In this manner, the separator 13 including the porous film 16 is fabricated.

First, the positive electrode lead 14 is coupled to the positive electrode 11 (the positive electrode end part 11T) by a method such as a welding method, and the negative electrode lead 15 is coupled to the negative electrode 12 (the negative electrode end part 12T) by a method such as a welding method. Thereafter, the positive electrode 11 and the negative electrode 12 are stacked on each other with the separator 13 including the porous film 16 interposed therebetween, following which the stack of the positive electrode 11, the negative electrode 12, and the separator 13 is wound about the winding axis J in the winding direction D to thereby fabricate a wound body. In this case, the increased-thickness part 13Y is aligned with respect to the positive electrode lead 14 and the negative electrode read 15 to allow the increased-thickness part 13Y to be disposed in the inter-lead region R1. Thereafter, the wound body is pressed by means of, for example, a pressing machine, and is thereby shaped into an elongated shape in a section intersecting the winding axis J.

Thereafter, the wound body is placed inside the depression part 20U, following which the outer package film 20 is folded in the direction of the arrow R. Thereafter, outer edges of two sides of the outer package film 20 (the fusion-bonding layer) are bonded to each other by a method such as a thermal-fusion-bonding method. The wound body is thereby contained inside the pouch-shaped outer package film 20.

Lastly, the electrolytic solution is injected into the pouch-shaped outer package film 20, following which the outer edges of the remaining one side of the outer package film 20 (the fusion-bonding layer) are bonded to each other by a method such as a thermal-fusion-bonding method. In this case, the sealing film 21 is interposed between the outer package film 20 and the positive electrode lead 14, and the sealing film 22 is interposed between the outer package film 20 and the negative electrode lead 15. The wound body is thereby impregnated with the electrolytic solution. Thus, the battery device 10 is fabricated. In this manner, the battery device 10 is sealed in the pouch-shaped outer package film 20. The secondary battery is thus assembled.

The assembled secondary battery is charged and discharged. Various conditions including an environment temperature, the number of times of charging and discharging (the number of cycles), and charging and discharging conditions may be freely chosen. This process forms a film on the surface of, for example, the negative electrode 12, to thereby bring the secondary battery into an electrochemically stable state. The secondary battery including the outer package film 20, that is, the secondary battery of the laminated-film type, is thus completed.

According to an embodiment, in the case where the positive electrode 11 and the negative electrode 12 are opposed to each other with the separator 13 interposed therebetween, the positive electrode lead 14 is coupled to the positive electrode 11 on the side of the positive electrode 11 opposed to the negative electrode 12, and the negative electrode lead 15 is coupled to the negative electrode 12 on the side of the negative electrode 12 opposed to the positive electrode 11, in a manner in which the negative electrode lead 15 is not opposed to the positive electrode lead 14. Further, the porous film 16 is disposed in the region sandwiched by the positive electrode lead 14 and the negative electrode lead 15. Accordingly, it is possible to achieve a superior cyclability characteristic for reasons described below.

FIG. 7 illustrates a sectional configuration of a secondary battery of a comparative example, and corresponds to FIG. 6. As illustrated in FIG. 7, the secondary battery of the comparative example has a configuration similar to the configuration of the secondary battery of the present embodiment (FIG. 6) except that the porous film 16 is not disposed in the region sandwiched by the positive electrode lead 14 and the negative electrode lead 15. In this case, the separator 13 is not folded in part, and therefore does not include the increased-thickness part 13Y. The separator 13 thus has a constant thickness TX.

In a process of manufacturing the secondary battery, a level difference occurs, in the region sandwiched by the positive electrode lead 14 and the negative electrode lead 15, due to the presence of each of the positive electrode lead 14 and the negative electrode lead 15. The level difference described here refers to a difference in height that results from each of a corner of the positive electrode lead 14 on an inner side (a side closer to the negative electrode lead 15) and a corner of the negative electrode lead 15 on an inner side (a side closer to the positive electrode lead 14).

In the secondary battery of the comparative example, as illustrated in FIG. 7, the porous film 16 is not disposed in the region sandwiched by the positive electrode lead 14 and the negative electrode lead 15. Accordingly, upon stacking of the positive electrode 11 and the negative electrode 12 on each other with the separator 13 interposed therebetween in the process of fabricating the battery device 10, the positive electrode 11 and the negative electrode 12 are each excessively curved to conform to the level difference generated in the region sandwiched by the positive electrode lead 14 and the negative electrode lead 15. This makes it difficult for each of the positive electrode 11 and the negative electrode 12 to be stacked in a substantially flat state.

In this case, a distance between the positive electrode 11 and the negative electrode 12 (an inter-electrode distance) varies and thus tends to increase in part. In particular, if the region sandwiched by the positive electrode lead 14 and the negative electrode lead 15 is present near a center part of the battery device 10, the positive electrode 11 and the negative electrode 12 are each relatively strongly affected by the level difference due to an influence of tension, and this makes it easier for the inter-electrode distance to increase significantly. Accordingly, at the location where the inter-electrode distance increases in part, diffusion resistance for the lithium ions locally increases upon charging and discharging of the secondary battery, and as a result, unintentional precipitation of lithium metal tends to occur.

Accordingly, the secondary battery of the comparative example tends to decrease in discharge capacity upon repeated charging and discharging, and thus has difficulty in achieving a superior cyclability characteristic.

Here, to reduce the level difference occurring in the region sandwiched by the positive electrode lead 14 and the negative electrode lead 15, a conceivable approach may be disposing a member (a non-porous film) for reducing the level difference in that region. However, simply disposing the non-porous film would lead to hindrance to a flow of the electrolytic solution and also lead to a decrease in volume of a storage space for the electrolytic solution at the center part of the battery device 10, due to the presence of the non-porous film. As a result, an increase in discharge capacity is limited, and the discharge capacity thus still tends to decrease upon repeated charging and discharging.

In contrast, in the secondary battery of an embodiment, the porous film 16 is disposed in the region sandwiched by the positive electrode lead 14 and the negative electrode lead 15, as illustrated in FIG. 6. The level difference is thus reduced through the use of the porous film 16.

In this case, even upon stacking of the positive electrode 11 and the negative electrode 12 on each other with the separator 13 interposed therebetween, the positive electrode 11 and the negative electrode 12 are each prevented from being easily curved excessively to conform to the level difference. Accordingly, it is easier for each of the positive electrode 11 and the negative electrode 12 to be stacked in a substantially flat state. This allows the inter-electrode distance to be substantially constant, thus helping to prevent the inter-electrode distance from increasing in part. Accordingly, diffusion resistance for the lithium ions is prevented from easily increasing locally upon the charging and discharging of the secondary battery, and unintentional precipitation of lithium metal is thus suppressed. Moreover, because the porous film 16 has porousness that allows lithium ions to pass therethrough, the use of the porous film 16 does not hinder the movement of the lithium ions upon charging and discharging. Further, even in the presence of the porous film 16, the electrolytic solution is easily movable and thus the flow of the electrolytic solution is secured. In addition, the volume of the storage space for the electrolytic solution at the center part of the battery device 10 increases, which results in an increased amount of a so-called surplus electrolytic solution.

The “surplus electrolytic solution” refers to an excess electrolytic solution other than the electrolytic solution with which the positive electrode 11, the negative electrode 12, and a portion (an inter-electrode portion) of the separator 13 sandwiched by the positive electrode 11 and the negative electrode 12 are each impregnated. The sum of an amount of the electrolytic solution with which the positive electrode 11, the negative electrode 12, and the inter-electrode portion are each impregnated and an amount of the surplus electrolytic solution is, as a matter of course, greater than the amount of the electrolytic solution with which the positive electrode 11, the negative electrode 12, and the inter-electrode portion are each impregnated, that is, an amount corresponding to a total volume of respective fine pores of the positive electrode 11, the negative electrode 12, and the inter-electrode portion. Accordingly, a total amount of electrolytic solution in a secondary battery that uses the porous film 16 is greater than a total amount of electrolytic solution in a secondary battery that uses a non-porous film.

Based upon the foregoing, the secondary battery, in an embodiment, does not easily decrease in discharge capacity even upon repeated charging and discharging, and is thus able to achieve a superior cyclability characteristic.

In particular, the porous film 16 may be a portion of the separator 13, and the separator 13 may be folded in part in the region sandwiched by the positive electrode lead 14 and the negative electrode lead 15. This allows the porous film 16 to be provided stably and easily through the use of a portion of the separator 13 which is porous. Accordingly, it is possible to achieve higher effects.

In this case, in particular, it becomes easier for the electrolytic solution to enter gaps between folds of the separator 13 overlapping each other, and the separator 13 thus improves in retention characteristic for the electrolytic solution. This facilitates impregnation of each of the positive electrode 11 and the negative electrode 12 with the electrolytic solution in a sufficient amount, thus making it easier for the charging and discharging reactions to proceed stably and continuously in the battery device 10. Accordingly, it is possible to achieve a superior battery life.

Further, the battery device 10 may include the flat part 10B, the positive electrode lead 14 may be coupled to the positive electrode 11 at the flat part 10B, and the negative electrode lead 15 may be coupled to the negative electrode 12 at the flat part 10B. This makes it easier to reduce the level difference through the use of the porous film 16. Accordingly, it is possible to achieve higher effects.

Further, the positive electrode 11 and the negative electrode 12 may be wound with the separator 13 interposed therebetween, and the porous film 16 may be disposed in the inter-lead region R1. This effectively reduces an influence of the level difference at a winding core part of the battery device 10 at which the positive electrode 11 and the negative electrode 12 are each significantly susceptible to the level difference due to the influence of tension. Accordingly, it becomes easier for each of the positive electrode 11 and the negative electrode 12 to be wound in a substantially flat state. This allows the inter-electrode distance to be substantially constant event in the case where the positive electrode 11 and the negative electrode 12 are wound. Accordingly, it is possible to achieve higher effects.

In this case, the area ratio R may be in the range from 20% to 80% both inclusive. This makes it easier to sufficiently reduce the level difference through the use of the porous film 16. Accordingly, it is possible to achieve higher effects.

Further, the separator 13 may have a multilayer structure including the porous layer 13A and the polymer compound layers 13B (including the inorganic particles). This prevents a positional displacement of the battery device 10 from easily occurring, and thus makes it possible to achieve higher effects. In this case, in particular, the secondary battery is prevented from easily swelling, and the heat resistance of the secondary battery improves. Accordingly, it is also possible to achieve a superior swelling characteristic and superior safety.

Further, the secondary battery may include a lithium-ion secondary battery. This makes it possible to stably obtain a sufficient battery capacity through the use of a lithium insertion phenomenon and a lithium extraction phenomenon. Accordingly, it is possible to achieve higher effects.

Next, modifications of the secondary battery will be described according to an embodiment. The configuration of the secondary battery described above is appropriately modifiable, as will be described below. Note that any two or more of the following series of modifications may be combined.

In FIG. 6, the separator 13 is folded in part to form the porous film 16. However, a method of forming the porous film 16 is not particularly limited as long as it is possible to form the porous film 16 using the separator 13.

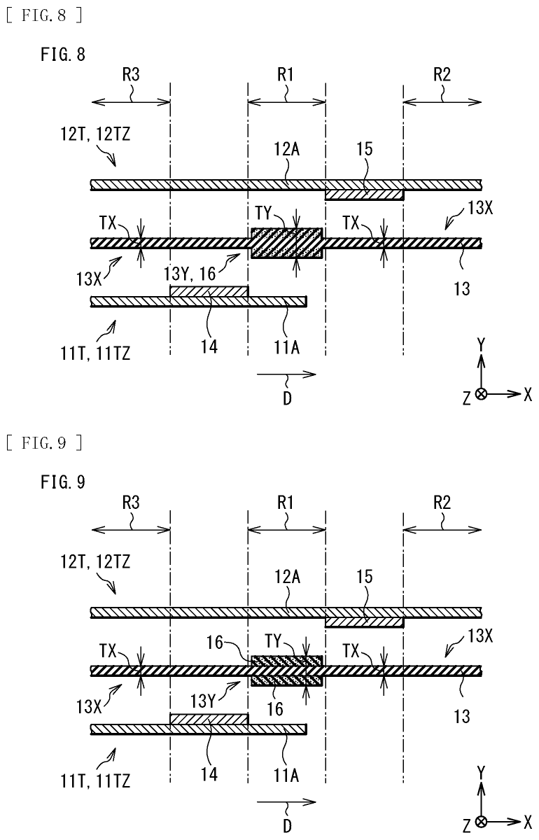

Specifically, as illustrated in FIG. 8 corresponding to FIG. 6, the separator 13 may be increased in thickness in part, instead of being folded in part. In this case, the thickness of the separator 13 is increased in part in the inter-lead region R1, and the porous film 16 is thus a portion of the separator 13. In other words, the porous film 16 is integral with the separator 13.

Here, the portion of the separator 13 protrudes toward each of the positive electrode end part 11T (the positive electrode extending part 11TZ) and the negative electrode end part 12T (the negative electrode extending part 12TZ). Accordingly, the separator 13 includes the paired constant-thickness parts 13X each having a relatively small thickness TX and the increased-thickness part 13Y having a relatively large thickness TY.

In this case also, the porous film 16 is provided using the separator 13 and the level difference is reduced through the use of the porous film 16. Accordingly, it is possible to achieve similar effects.

Note that although not specifically illustrated here, the portion of the separator 13 may protrude only toward the positive electrode end part 11T and not toward the negative electrode end part 12T. Alternatively, the portion of the separator 13 may protrude only toward the negative electrode end part 12T and not toward the positive electrode end part 11T. Even in such cases, the increased-thickness part 13Y having the thickness TY is provided and it is thus possible to achieve similar effects.

However, to improve the retention characteristic of the battery device 10 for the electrolytic solution, as described above, folding the separator 13 in part is preferable to increasing the thickness of the separator 13 in part.

In FIG. 8, to form the porous film 16, the thickness of the separator 13 is increased in part to thereby provide the porous film 16 integral with the separator 13. However, the method of forming the porous film 16 is not particularly limited as long as it is possible to provide the porous film 16.

Specifically, as illustrated in FIG. 9 corresponding to FIG. 8, the porous films 16 may be paired and provided on respective opposite sides of the separator 13. The paired porous films 16 may thus be provided separately from the separator 13. A method of fixing the porous films 16 to the separator 13 is not particularly limited, and the porous films 16 may thus be bonded to the separator 13 using a bonding member such as an adhesive or a double-stick tape, or another method may be used.

Here, the porous films 16 are provided on the respective opposite sides of the separator 13, that is, on both a surface opposed to the positive electrode end part 11T and a surface opposed to the negative electrode end part 12T. The separator 13 provided with the paired porous films 16 thus includes the paired constant-thickness parts 13X each having a relatively small thickness TX and the increased-thickness part 13Y having a relatively large thickness TY.

In this case also, the porous film 16 is provided and the level difference is reduced through the use of the porous film 16. Accordingly, it is possible to achieve similar effects.

Note that although not specifically illustrated here, the porous film 16 may be provided only on one of the opposite sides of the separator 13, that is, one of the surface opposed to the positive electrode end part 11T or the surface opposed to the negative electrode end part 12T. Even in such a case, the increased-thickness part 13Y having the thickness TY is provided and it is thus possible to achieve similar effects.

In FIG. 6, the porous film 16 is disposed only in the inter-lead region R1 of the three regions (the inter-read region R1, the inner winding region R2, and the outer winding region R3).

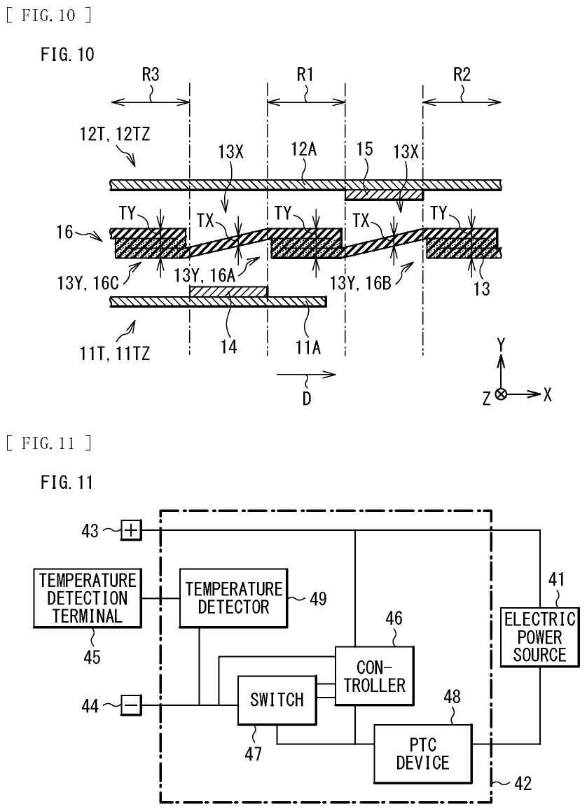

However, as illustrated in FIG. 10 corresponding to FIG. 6, the separator 13 may be folded in part also in the inner winding region R2 to thereby provide a porous film 16 integral with the separator 13 in the inner winding region R2, and may be folded in part also in the outer winding region R3 to thereby provide a porous film 16 integral with the separator 13 in the outer winding region R3.

In the following, to distinguish the three porous films 16 from each other, the porous film 16 disposed in the inter-lead region R1 will be referred to as a porous film 16A, the porous film 16 disposed in the inner winding region R2 will be referred to as a porous film 16B, and the porous film 16 disposed in the outer winding region R3 will be referred to as a porous film 16C.

In this case, in the inter-read region R1, the level difference resulting from the inner-side corner of each of the positive electrode lead 14 and the negative electrode lead 15 is reduced by the porous film 16A. In the inner winding region R2, a level difference resulting from an outer-side corner of the negative electrode lead 15 is reduced by the porous film 16B. In the outer winding region R3, a level difference resulting from an outer-side corner of the positive electrode lead 14 is reduced by the porous film 16C.

Accordingly, as compared with a case of using the porous film 16A only, the use of the porous films 16A to 16C helps to further prevent the inter-electrode distance from easily increasing in part. As a result, a local increase in diffusion resistance for the lithium ions is suppressed further, and precipitation of lithium metal is suppressed further. This helps to further prevent the discharge capacity from decreasing easily even upon repeated charging and discharging, and thus makes it possible to achieve a further superior cyclability characteristic.

Here, although not specifically illustrated, cases where the porous films 16B and 16C are used are not limited to where both of the porous films 16B and 16C are used. Thus, only the porous film 16B may be used, or only the porous film 16C may be used. Even in such a case, the discharge capacity is further prevented from decreasing easily even upon repeated charging and discharging, as compared with the case of using the porous film 16A only. Accordingly, it is possible to achieve higher effects.

The electrolytic solution which is a liquid electrolyte is used. However, although not specifically illustrated here, an electrolyte layer which is a gel electrolyte may be used instead of the electrolytic solution.

In the battery device 10 including the electrolyte layer, the positive electrode 11 and the negative electrode 12 are alternately stacked with the separator 13 and the electrolyte layer interposed therebetween. The electrolyte layer is interposed between the positive electrode 11 and the separator 13, and between the negative electrode 12 and the separator 13.

Specifically, the electrolyte layer includes a polymer compound together with the electrolytic solution. The electrolytic solution is held by the polymer compound in the electrolyte layer. The configuration of the electrolytic solution is as described above. The polymer compound includes, for example, polyvinylidene difluoride. In a case of forming the electrolyte layer, a precursor solution is prepared that includes, for example, the electrolytic solution, the polymer compound, and an organic solvent, following which the precursor solution is applied on one side or opposite sides of each of the positive electrode 11 and the negative electrode 12.

In the case where the electrolyte layer is used also, similar effects are obtainable because lithium ions are movable between the positive electrode 11 and the negative electrode 12 via the electrolyte layer. In this case, in particular, the storage space for the electrolytic solution is generated through the use of the porous film 16 as described above even with the electrolyte layer, and the surplus electrolytic solution is thus secured.

Next, a description is given of applications (application examples) of the above-described secondary battery according to an embodiment.

The applications of the secondary battery are not particularly limited as long as they are, for example, machines, equipment, instruments, apparatuses, or systems (an assembly of a plurality of pieces of equipment, for example) in which the secondary battery is usable mainly as a driving power source, an electric power storage source for electric power accumulation, or any other source. The secondary battery used as a power source may serve as a main power source or an auxiliary power source. The main power source is preferentially used regardless of the presence of any other power source. The auxiliary power source may be used in place of the main power source, or may be switched from the main power source on an as-needed basis. In a case where the secondary battery is used as the auxiliary power source, the kind of the main power source is not limited to the secondary battery.

Specific examples of the applications of the secondary battery include: electronic equipment including portable electronic equipment; portable life appliances; apparatuses for data storage; electric power tools; battery packs to be mounted as detachable power sources on, for example, laptop personal computers; medical electronic equipment; electric vehicles; and electric power storage systems. Examples of the electronic equipment include video cameras, digital still cameras, mobile phones, laptop personal computers, cordless phones, headphone stereos, portable radios, portable televisions, and portable information terminals. Examples of the portable life appliances include electric shavers. Examples of the apparatuses for data storage include backup power sources and memory cards. Examples of the electric power tools include electric drills and electric saws. Examples of the medical electronic equipment include pacemakers and hearing aids. Examples of the electric vehicles include electric automobiles including hybrid automobiles. Examples of the electric power storage systems include home battery systems for accumulation of electric power for a situation such as emergency. Note that the secondary battery may have a battery structure of the above-described laminated-film type, a cylindrical type, or any other type. Further, multiple secondary batteries may be used, for example, as a battery pack or a battery module.

In particular, the battery pack and the battery module are each effectively applied to relatively large-sized equipment, etc., including an electric vehicle, an electric power storage system, and an electric power tool. The battery pack, as will be described later, may include a single battery, or may include an assembled battery. The electric vehicle is a vehicle that operates (travels) using the secondary battery as a driving power source, and may be an automobile that is additionally provided with a driving source other than the secondary battery as described above, such as a hybrid automobile. The electric power storage system is a system that uses the secondary battery as an electric power storage source. An electric power storage system for home use accumulates electric power in the secondary battery which is an electric power storage source, and the accumulated electric power may thus be utilized for using, for example, home appliances.

Some typical application examples of the secondary battery will now be described in detail. The configurations of the application examples described below are mere examples, and are appropriately modifiable.

FIG. 11 illustrates a block configuration of a battery pack. The battery pack described here is a simple battery pack (a so-called soft pack) including one secondary battery, and is to be mounted on, for example, electronic equipment typified by a smartphone.

As illustrated in FIG. 11, the battery pack includes an electric power source 41 and a circuit board 42. The circuit board 42 is coupled to the electric power source 41, and includes a positive electrode terminal 43, a negative electrode terminal 44, and a temperature detection terminal 45. The temperature detection terminal 45 is a so-called T terminal.

The electric power source 41 includes one secondary battery. The secondary battery has a positive electrode lead coupled to the positive electrode terminal 43 and a negative electrode lead coupled to the negative electrode terminal 44. The electric power source 41 is countable to outside via the positive electrode terminal 43 and the negative electrode terminal 44, and is thus chargeable and dischargeable via the positive electrode terminal 43 and the negative electrode terminal 44. The circuit board 42 includes a controller 46, a switch 47, a thermosensitive resistive device (a positive temperature coefficient (PTC) device) 48, and a temperature detector 49. However, the PTC device 48 may be omitted.

The controller 46 includes, for example, a central processing unit (CPU) and a memory, and controls an overall operation of the battery pack. The controller 46 detects and controls a use state of the electric power source 41 on an as-needed basis.

If a battery voltage of the electric power source 41 (the secondary battery) reaches an overcharge detection voltage or an overdischarge detection voltage, the controller 46 turns off the switch 47. This prevents a charging current from flowing into a current path of the electric power source 41. In addition, if a large current flows upon charging or discharging, the controller 46 turns off the switch 47 to block the charging current. The overcharge detection voltage and the overdischarge detection voltage are not particularly limited. For example, the overcharge detection voltage is 4.2 V±0.05 V and the overdischarge detection voltage is 2.4 V±0.1 V.

The switch 47 includes, for example, a charge control switch, a discharge control switch, a charging diode, and a discharging diode. The switch 47 performs switching between coupling and decoupling between the electric power source 41 and external equipment in accordance with an instruction from the controller 46. The switch 47 includes, for example, a metal-oxide-semiconductor field-effect transistor (MOSFET) including a metal-oxide semiconductor. The charging and discharging currents are detected on the basis of an ON-resistance of the switch 47.

The temperature detector 49 includes a temperature detection device such as a thermistor. The temperature detector 49 measures a temperature of the electric power source 41 using the temperature detection terminal 45, and outputs a result of the temperature measurement to the controller 46. The result of the temperature measurement to be obtained by the temperature detector 49 is used, for example, in a case where the controller 46 performs charge/discharge control upon abnormal heat generation or in a case where the controller 46 performs a correction process upon calculating a remaining capacity.

### EXAMPLES

A description is given of Examples of the present technology below according to an embodiment.

### Experiment Examples 1 to 10

Secondary batteries (lithium-ion secondary batteries) of the laminated-film type illustrated in FIGS. 1 to 6, 9, and 10 were fabricated, following which the secondary batteries were evaluated for cyclability characteristic as described below.

### [Fabrication of Secondary Battery]

The secondary batteries were fabricated in accordance with the following procedure.

### (Fabrication of Positive Electrode)

First, 91 parts by mass of the positive electrode active material (lithium cobalt oxide (LiCoO₂)), 3 parts by mass of the positive electrode binder (polyvinylidene difluoride), and 6 parts by mass of the positive electrode conductor (graphite) were mixed with each other to thereby obtain a positive electrode mixture. Thereafter, the positive electrode mixture was put into an organic solvent (N-methyl-2-pyrrolidone), following which the organic solvent was stirred to thereby prepare a paste positive electrode mixture slurry. Thereafter, the positive electrode mixture slurry was applied on opposite sides of the positive electrode current collector 11A (an aluminum foil having a thickness of 12 μm) by means of a coating apparatus, following which the applied positive electrode mixture slurry was dried to thereby form the positive electrode active material layers 11B. In this case, the positive electrode current collector 11A was exposed at the positive electrode end part 11T by adjusting the application range of the positive electrode mixture slurry in such a manner as to form the positive electrode active material layers 11B on neither of opposite end parts of the positive electrode current collector 11A in the winding direction D. Lastly, the positive electrode active material layers 11B were compression-molded by means of a roll pressing machine. The positive electrode active material layers 11B were thus formed on the respective opposite sides of the positive electrode current collector 11A. In this manner, the positive electrode 11 was fabricated.

### (Fabrication of Negative Electrode)

First, 93 parts by mass of the negative electrode active material (artificial graphite which is a carbon material) and 7 parts by mass of the negative electrode binder (polyvinylidene difluoride) were mixed with each other to thereby obtain a negative electrode mixture. Thereafter, the negative electrode mixture was put into an organic solvent (N-methyl-2-pyrrolidone), following which the organic solvent was stirred to thereby prepare a paste negative electrode mixture slurry. Thereafter, the negative electrode mixture slurry was applied on opposite sides of the negative electrode current collector 12A (a copper foil having a thickness of 15 μm) by means of a coating apparatus, following which the applied negative electrode mixture slurry was dried to thereby form the negative electrode active material layers 12B. In this case, the negative electrode current collector 12A was exposed at the negative electrode end part 12T by adjusting the application range of the negative electrode mixture slurry in such a manner as to form the negative electrode active material layers 12B on neither of opposite end parts of the negative electrode current collector 12A in the winding direction D. Lastly, the negative electrode active material layers 12B were compression-molded by means of a roll pressing machine. The negative electrode active material layers 12B were thus formed on the respective opposite sides of the negative electrode current collector 12A. In this manner, the negative electrode 12 was fabricated.

### (Preparation of Electrolytic Solution)

The electrolyte salt (lithium hexafluorophosphate (LiPF₆)) was added to a solvent (ethylene carbonate, propylene carbonate, diethyl carbonate, and propyl propionate), following which the solvent was stirred. In this case, a mixture ratio (a weight ratio) between ethylene carbonate, propylene carbonate, diethyl carbonate, and propyl propionate in the solvent was set to 30:10:40:20, and the content of the electrolyte salt with respect to the solvent was set to 1 mol/kg. The electrolyte salt was thereby dissolved in the solvent. In this manner, the electrolytic solution was prepared.

### (Assembly of Secondary Battery)

First, the positive electrode lead 14 including aluminum was welded to the positive electrode end part 11T (the positive electrode extending part 11TZ), and the negative electrode lead 15 including copper was welded to the negative electrode end part 12T (the negative electrode extending part 12TZ).

Thereafter, the positive electrode 11 and the negative electrode 12 were stacked on each other with the separator 13 interposed therebetween, following which the stack of the positive electrode 11, the negative electrode 12, and the separator 13 was wound about the winding axis J in the winding direction D to thereby fabricate the wound body. Thereafter, the wound body was pressed by means of a pressing machine, and was thereby shaped into an elongated shape in a section intersecting the winding axis J. In this case, as described in Table 1, used was the separator 13 provided with the porous film 16 in advance. The configuration, location, and area ratio R of the porous film 16, and the configuration (single-layer structure or multilayer structure) of the separator 13 were as listed in Table 1.

As the separator 13 having the single-layer structure, used was a fine-porous polyethylene film having a thickness of 15 μm.

In a case of fabricating the separator 13 having the multilayer structure, first, a polymer compound (polyvinylidene difluoride) and inorganic particles (an aluminum oxide having a median diameter D50 of 0.3 μm) were put into an organic solvent (N-methyl-2-pyrrolidone), following which the organic solvent was stirred to thereby obtain a dispersion liquid. In this case, a mixture ratio (a weight ratio) between the polymer compound and the inorganic particles was set to 20:80. Thereafter, the porous layer 13A (a fine-porous polyethylene film having a thickness of 15 μm) was immersed in the dispersion liquid. Thereafter, the porous layer 13A was taken out of the dispersion liquid, following which the porous layer 13A was dried to thereby form the polymer compound layer 13B. Thereafter, a base layer was washed with an aqueous solvent (pure water) to thereby remove the organic solvent. Lastly, the porous layer 13A was dried with hot air having a temperature of 80° C. The polymer compound layer 13B (having a total thickness of 30 μm) including the polymer compound and the inorganic particles was thus formed on each of opposite sides of the porous layer 13A. In this manner, the separator 13 having the multilayer structure was fabricated.

As the configuration of the porous film 16, two kinds of configurations were used as listed in Table 1. For a first kind of configuration (integral (folded)), the separator 13 was folded in part; thus, the porous film 16 was provided integrally with the separator 13. For a second kind of configuration (separate (attached)), the paired porous films 16 (each being a fine-porous polyethylene film having a thickness of 15 μm) were attached to the respective opposite sides of the separator 13 with an adhesive; thus, the porous films 16 were provided separately from the separator 13. To adjust the area ratio R, the porous film 16 was varied in size (planar size).

For comparison, a wound body was fabricated using the separator 13 provided with no porous film 16 in advance. Further, for comparison, a wound body was fabricated using the separator 13 to which paired non-porous films (each being a vinyl tape having a thickness of 15 μm) were attached instead of the paired porous films 16.

Thereafter, the outer package film 20 was folded in such a manner as to sandwich the wound body placed in the depression part 20U, following which the outer edges of two sides of the outer package film 20 were thermal-fusion-bonded to each other to thereby allow the wound body to be contained inside the pouch-shaped outer package film 20. As the outer package film 20, an aluminum laminated film was used in which a fusion-bonding layer (a polypropylene film having a thickness of 30 μm), a metal layer (an aluminum foil having a thickness of 40 μm), and a surface protective layer (a nylon film having a thickness of 25 μm) were stacked in this order from the inner side.

Thereafter, the electrolytic solution was injected into the pouch-shaped outer package film 20 and thereafter, the outer edges of the remaining one side of the outer package film 20 were thermal-fusion-bonded to each other in a reduced-pressure environment. In this case, the sealing film 21 (a polypropylene film having a thickness of 5 μm) was interposed between the outer package film 20 and the positive electrode lead 14, and the sealing film 22 (a polypropylene film having a thickness of 5 μm) was interposed between the outer package film 20 and the negative electrode lead 15. The wound body was thereby impregnated with the electrolytic solution. Thus, the battery device 10 was fabricated. In this manner, the battery device was sealed in the outer package film 20, and the secondary battery was thus assembled.

### (Stabilization of Secondary Battery)

The secondary battery was charged and discharged in an ambient temperature environment (at a temperature of 25° C.). Upon the charging, the secondary battery was charged with a constant current of 0.1 C until a battery voltage reached 4.35 V, and was thereafter charged with a constant voltage of 4.35 V until a current reached 0.05 C. Upon the discharging, the secondary battery was discharged with a constant current of 0.1 C until the battery voltage reached 3.0 V. Note that 0.1 C is a value of a current that causes a battery capacity (a theoretical capacity) to be completely discharged in 10 hours, and 0.05 C is a value of a current that causes the battery capacity to be completely discharged in 20 hours.

As a result, a film was formed on the surface of, for example, the negative electrode 12 to stabilize the state of the secondary battery. Thus, the secondary battery of the laminated-film type was completed.

Evaluation of the secondary batteries for their cyclability characteristics revealed the results presented in Table 1.

In a case of examining the cyclability characteristic, first, the secondary battery was charged and discharged in an ambient temperature environment (at a temperature of 25° C.), and a discharge capacity (a first-cycle discharge capacity) was measured. Thereafter, the secondary battery was repeatedly charged and discharged in the same environment until the total number of cycles reached 500, and the discharge capacity (a 500th-cycle discharge capacity) was measured. Lastly, the following was calculated: capacity retention rate (%)=(500th-cycle discharge capacity/first-cycle discharge capacity)×100.

Charging and discharging conditions were similar to those in stabilizing the secondary battery described above, except that the current at the time of charging and the current at the time of discharging were each changed to 1 C. Note that 1 C is a value of a current that causes the battery capacity to be completely discharged in 1 hour.

### [Table 1]

### Table 1

TABLE 1

| | Porous film | | | | |
|---|---|---|---|---|---|
| | | | Area | | Capacity |
| Experiment | | | ratio | Separator | rate (%) |
| example | Configuration | Location | R | Configuration | retention |
| 1 | Integral | R1, R2, R3 | 10 | Multilayer | 83 |
| | (folded) | | | structure | |
| 2 | Integral | R1, R2, R3 | 20 | Multilayer | 85 |
| | (folded) | | | structure | |
| 3 | Integral | R1, R2, R3 | 50 | Multilayer | 85 |
| | (folded) | | | structure | |
| 4 | Integral | R1, R2, R3 | 80 | Multilayer | 88 |
| | (folded) | | | structure | |
| 5 | Integral | R1, R2, R3 | 90 | Multilayer | 82 |
| | (folded) | | | structure | |
| 6 | Integral | R1 | 80 | Multilayer | 83 |
| | (folded) | | | structure | |
| 7 | Integral | R1, R2, R3 | 80 | Single-layer | 82 |
| | (folded) | | | structure | |
| 8 | Separate | R1, R2, R3 | 80 | Multilayer | 82 |
| | (attached) | | | structure | |
| 9 | — | — | — | Single-layer | 75 |
| | | | | structure | |
| 10 | — | R1 | 80 | Single-layer | 79 |
| | (Non-porous | | | structure | |
| | film) | | | | |

As indicated in Table 1, the cyclability characteristic of the secondary battery greatly varied depending on, for example, the presence or absence of the porous film 16 and the configuration of the porous film 16.

Specifically, in a case where the non-porous film was used instead of the porous film 16 (Experiment example 10), the capacity retention rate increased only slightly as compared with a case where neither the porous film 16 nor the non-porous film was used (Experiment example 9). Thus, the capacity retention rate did not sufficiently increase.

In contrast, in a case where the porous film 16 was used (Experiment examples 1 to 8), the capacity retention rate greatly increased as compared with the case where neither the porous film 16 nor the non-porous film was used (Experiment example 9). Thus, the capacity retention rate sufficiently increased.

In particular, the following tendencies were obtained in the case where the porous film 16 was used. Firstly, in a case where the porous film 16 integral with the separator 13 was used (Experiment example 4), the capacity retention rate increased more than in a case where the porous film 16 separate from the separator 13 was used (Experiment example 8). Secondly, in a case where the porous film 16 was disposed not only in the inter-lead region R1 but also in each of the inner winding region R2 and the outer winding region R3 (Experiment example 4), the capacity retention rate increased more than in a case where the porous film 16 was disposed only in the inter-lead region R1 (Experiment example 6). Thirdly, in a case where the area ratio R was within the range from 20% to 80% both inclusive (Experiment examples 2 to 4), the capacity retention rate increased more than in a case where the area ratio R was less than 20% or greater than 80% (Experiment examples 1 and 5). Fourthly, in a case where the separator 13 having the multilayer structure was used (Experiment example 4), the capacity retention rate increased more than in a case where the separator 13 having the single-layer structure was used (Experiment example 7).

Based upon the results presented in Table 1, a high capacity retention rate was obtained in a case where the positive electrode 11 and the negative electrode 12 were opposed to each other with the separator 13 interposed therebetween, where the positive electrode lead 14 was coupled to the positive electrode 11 and the negative electrode lead 15 was coupled to the negative electrode 12, and where the porous film 16 was disposed in the region sandwiched by the positive electrode lead 14 and the negative electrode lead 15. Accordingly, a superior cyclability characteristic of the secondary battery was obtained.

Although the present technology has been described herein, the configuration of the present technology is not limited to the description, and is therefore modifiable in a variety of suitable ways.

For example, although the description above relates to the case where the secondary battery has a battery structure of the laminated-film type, the battery structure is not particularly limited, and may thus be of any other type such as a cylindrical type, a prismatic type, a coin type, or a button type. In this connection, the outer package member is not particularly limited in kind, and thus a flexible film may be used or a rigid metal can may be used.

Further, although the description above relates to the case where the battery device has an elongated shape in a section thereof, the sectional shape is not particularly limited, and may be a non-elongated shape such as a circular shape.

Further, although the description above relates to the case where the battery device has a wound-type device structure, the device structure of the battery device is not particularly limited, and may thus be any other device structure such as a stacked-type device structure in which the electrodes (the positive electrode and the negative electrode) are stacked, or a zigzag-folded-type device structure in which the electrodes (the positive electrode and the negative electrode) are folded in a zigzag manner.

Further, although the description above relates to the case where the electrode reactant is lithium, the electrode reactant is not particularly limited. Specifically, as described above, the electrode reactant may be another alkali metal such as sodium or potassium, or may be an alkaline earth metal such as beryllium, magnesium, or calcium. Other than the above, the electrode reactant may be another light metal such as aluminum.

The effects described herein are mere examples, and effects of the present technology are therefore not limited to those described herein. Accordingly, the present technology may achieve any other suitable effect.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
a battery device including a positive electrode and a negative electrode that are opposed to each other with a separator interposed therebetween;
a positive electrode terminal coupled to the positive electrode on a side of the positive electrode opposed to the negative electrode;
a negative electrode terminal coupled to the negative electrode on a side of the negative electrode opposed to the positive electrode, the negative electrode terminal being positioned not to be opposed to the positive electrode terminal; and
a porous member disposed in a region between the positive electrode terminal and the negative electrode terminal.

2. The secondary battery according to claim 1, wherein
the porous member is a portion of the separator, and
the separator is folded in part in the region between the positive electrode terminal and the negative electrode terminal.

3. The secondary battery according to claim 1, wherein
the porous member is a portion of the separator, and
the separator is increased in thickness in part in the region between the positive electrode terminal and the negative electrode terminal.

4. The secondary battery according to claim 1, wherein
the battery device includes a flat part,
the positive electrode terminal is coupled to the positive electrode at the flat part, and
the negative electrode terminal is coupled to the negative electrode at the flat part.

5. The secondary battery according to claim 1, wherein
the positive electrode and the negative electrode are wound in a winding direction with the separator interposed therebetween,
the positive electrode terminal is coupled to an end part of the positive electrode on an inner side of winding in the winding direction,
the negative electrode terminal is coupled to an end part of the negative electrode on the inner side of the winding in the winding direction, and
the porous member is disposed in a first region sandwiched by the positive electrode terminal and the negative electrode terminal in the winding direction.

6. The secondary battery according to claim 5, wherein a ratio of an area of the porous member to an area of the first region is greater than or equal to 20% and less than or equal to 80%.

7. The secondary battery according to claim 5, wherein
the positive electrode and the negative electrode are wound about a winding axis,
a section of the battery device intersecting the winding axis has an elongated shape defined by a major axis and a minor axis,
the end part of the positive electrode on the inner side of the winding includes a positive electrode extending part that extends in a direction of the major axis, and the positive electrode terminal is coupled to the positive electrode extending part,
the end part of the negative electrode on the inner side of the winding includes a negative electrode extending part that extends in the direction of the major axis, and the negative electrode terminal is coupled to the negative electrode extending part, and
the porous member is further disposed in a second region, a third region, or both within a range over which the positive electrode extending part and the negative electrode extending part each extend in the direction of the major axis, the second region lying on the inner side of the winding relative to one of the positive electrode terminal or the negative electrode terminal, the third region lying on an outer side of the winding relative to another of the positive electrode terminal or the negative electrode terminal.

8. The secondary battery according to claim 7, wherein
the separator includes:
a porous layer having paired surfaces that are each opposed to a corresponding one of the positive electrode or the negative electrode; and
a polymer compound layer provided on at least one of the paired surfaces and including inorganic particles.

9. The secondary battery according to claim 1, wherein the secondary battery comprises a lithium-ion secondary battery.
